(19) United States
(12) Patent Application Publication
(10) Pub. No.: US 2008/0111316 A1
(43) Pub. Date: May 15, 2008

(54) Rotary Sealing Joint

(75) Inventors: Florent Sellas, Colombes (FR); Dominique Veret, Verrieres Le Buisson (FR)

Correspondence Address: YOUNG & THOMPSON, 209 Madison Street, Suite 500, ALEXANDRIA, VA, 22314, US

(73) Assignee: SIEMENS AUTOMOTIVE HYDRAULICS SA, ASNIERES SUR SEINE (FR)

(21) Appl. No.: 11/910,346

(22) PCT Filed: Mar. 17, 2006
(86) PCT No.: PCT/FR06/00603

§ 371 Date: Oct. 1, 2007

(30) Foreign Application Priority Data
Apr. 1, 2005 (FR) 0503213

(51) Int. Cl. B60T 11/236

(52) U.S. Cl. 277/436

(57) ABSTRACT

The invention concerns a safety device for preventing overpressure occurring in the oil part (3) of a transfer pump supplying a fuel such as high-pressure gasoline to an engine characterized in that it consists of a rotary sealing joint (10) separating the oil part (3) of the pump and the oil part (7) of said engine.

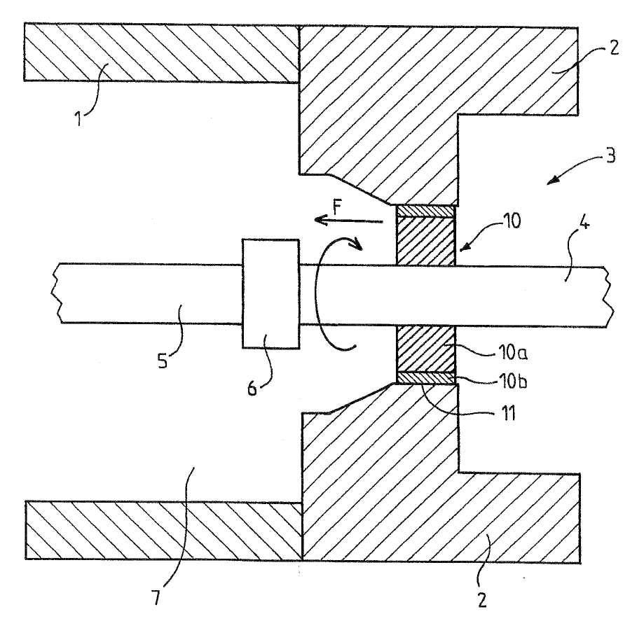

The present invention relates to a rotary sealing joint which, whilst ensuring good static and dynamic sealing, must be expelled from its seat when it is subjected to overpressure.

This invention and the problem for which it provides a solution will be described hereafter with respect to the single FIGURE, which is a schematic representation.

In this FIGURE, reference 1 designates a portion of a motor block and reference 2 designates a portion of a pump casing.

Preferably, the pump is a pump of the transfer pump type, comprising an oil portion and a gasoline portion so as to be able to provide gasoline at high pressure.

The FIGURE being schematic, reference 3 refers to a portion of the oil portion of the pump.

This oil portion 3 is traversed by a shaft 4 which is the pump shaft.

This shaft 4 is connected to the motor shaft 5 by a coupling mechanism 6.

The chamber 7 which is located in the portion 1 of the motor block, contains a mist of motor oil.

The problem to be solved is the following:

The failure of a component of the transfer pump can give rise to an abrupt increase in pressure of the oil in 3.

It appears that if no safety means is provided, this could give rise to rupture of a component of the oil part and an external leakage. This external leakage is not permissible; on the other hand, a leakage of the oil portion 3 toward the chamber 7 is acceptable.

It would be possible to arrange an overpressure valve in the chamber 3, but this would give rise to a substantial increase in the price of production of the transfer pump, which must be installed on automobile motors and hence must be of as low a price as possible.

The solution according to the invention consists in using the rotary joint 10, which separates the chambers 3 (oil portion of the pump) and 7 (oil portion of the motor) as a safety valve that can rupture.

To this end, said rotary joint 20 is constituted by two concentric portions 10a and 10b of materials having different hardnesses.

The internal portion 10a is constituted by a hard material, for example rubber of a Shore hardness of 80; whilst the external portion or crown 10b has a lower hardness. The thickness of this external crown 10b is less than that of the internal portion 10a.

The two-material joint 10 is, as usual, ensleeved forcibly in the opening 11 which separates the chambers 3 and 7. The shaft 4 turns within the portion 10a of the rotary joint 10, which remains fixed in its seat.

In case of abrupt overpressure in the chamber 3, the two-material joint 10 will be expelled from its seat 11 in the direction of the arrow F, which will have the double effect on the one hand of causing the overpressure to fall, and on the other hand of recovering the leakage of oil that arises in the oil circuit of the motor: there will thus be no external leakage of oil, or of fuel or even a gasoline-oil mixture.

1. Rotary joint characterized by the fact that it constitutes an overpressure valve between the motor oil chamber (7) of a motor block (1) and the oil portion (3) of a high pressure pump driven by a shaft (4) passing through said rotary joint (10), this latter being expelled from its seat (11) in said chamber (7) when an overpressure occurs in the oil portion (3) of the pump; such that the oil overpressure in the oil portion (3) of the pump will be recovered in a chamber (7) of the motor which reduces any overpressure in the pump.

2. Safety device according to claim 1 characterized by the fact that the rotary sealing joint is constituted by two concentric parts (10a, 10b), the internal part 10a having a hardness and thickness greater than those of the external part 10b.
